(19) United States
(12) Patent Application Publication
(10) Pub. No.: US 2013/0160666 A1
(43) Pub. Date: Jun. 27, 2013

(54) PLATE MATERIAL FOR DIRECT PLATEMAKING OF INK-JET PRINTING AND INK-JET PRINTING METHOD

(71) Applicants: Haihua Zhou, Beijing (CN); Yanlin Song, Beijing (CN)

(72) Inventors: Haihua Zhou, Beijing (CN); Yanlin Song, Beijing (CN)

(73) Assignee: Institute of Chemistry, Chinese Academy of Science, Beijing (CN)

(21) Appl. No.: 13/806,700

(22) PCT Filed: Apr. 27, 2010
(86) PCT No.: PCT/CN2010/072239

§ 371 Date: Dec. 21, 2012

(51) Int. Cl. C09D 11/10; B41C 1/10

(52) U.S. Cl. CPC C09D 11/10; B41C 1/10
USPC 101/395; 101/483

(57) ABSTRACT

A plate for inkjet computer-to-plate and an inkjet printing method are disclosed. The plate is obtained by coating adhesive on the surface of metallic base followed by coating ink repulsive liquid, and a polymer film can be further covered on the obtained plate as protective layer. The adhesive improves the adhesion force between the metallic base and the ink repulsive layer, and the obtained ink repulsive layer is not sticky to the printing ink during printing. Therefore, without undergoing the treatments of electrolytic graining and anodizing, the plate of the present invention can achieve excellent printing durability and high resolution, thereby avoiding serious environmental pollution of the waste acid solution and waste base solution produced in the process of electrolytic graining and anodizing.

### FIELD OF THE INVENTION

The present invention pertains to the field of printing plate, and particularly relates to a plate for inkjet computer-to-plate and an inkjet printing method.

### BACKGROUND OF THE INVENTION

Offset lithographic printing is dominant in Chinese printing industry owing to its excellent performance. At present, the main printing substrate is aluminum substrate, and other metallic substrate, such as copper substrate and zinc substrate, can also be used. The aluminum substrate is generally undergoes treatments of anodizing and graining, so as to improve the printing durability and the resolution of aluminum plate (refer to CN85100875A). Through investigation, it is found that for a large-scale anodizing factory for aluminum substrate, the consumption of electric energy is 2,000,000 KWh per month, which leads to a cost of about $160,000/month, and in order to produce 10,000 m² of aluminum substrate, the output of the waste acid solution is about two tons and the output of the waste base solution is about three tons. The discharge of a large amount of the waste acid solution and the waste base solution has caused serious environmental pollution.

### SUMMARY OF THE INVENTION

An object of the present invention is to provide a plate for inkjet computer-to-plate with excellent printing durability and resolution, which can be obtained without the treatments of electrolytic graining and anodizing, so as to overcome the environmental hazard resulted from the waste acid solution and the waste base solution produced in the process of electrolytic graining and anodizing of metallic substrates in the prior art.

Another object of the present invention is to provide an inkjet printing method using the plate of the present invention.

According to the first object of the present invention, a plate for inkjet computer-to-plate is provided, which comprises a metallic base, an adhesive layer coated on the surface of the metallic base and an ink repulsive layer coated on the adhesive layer.

The adhesive in the adhesive layer is at least one selected from the group consisting of epoxy resin, polyurethane, polyolefin, polyester, styrene-butadiene rubber, gelatin, polyvinyl butyral, polyamide, rosin resin, polyvinyl alcohol, alkyd resin, polyvinyl acetate and etc. The polyolefin is at least one selected from the group consisting of polypropylene, polyvinyl chloride and polystyrene.

The ink-repulsive layer is a mixture of silicon rubber and curing agent or the ink repulsive layer is fluorine-containing resin.

The plate of the present invention can further comprise a protective layer, which is covered on the ink-repulsive layer. Preferably, the protective layer is a polymer film with a thickness of 1˜20 μm.

The polymer in the polymer film may be at least one selected from polyethylene, polypropylene, polypentene, polyvinylidene, polyallene, polyvinyl alcohol, polyvinyl butyral, polystyrene, polyethylene terephthalate, polyvinyl chloride, poly(vinylidene dichloride) resin and etc.

The adhesive layer is obtained by coating and drying adhesive sol. The adhesive sol for coating consists of solute and solvent. The concentration of the solute in the adhesive sol may be 0.0515 wt % and the coating amount of the adhesive sol may be 0.00110 g/m². Preferably, the adhesive layer is coated on the whole surface of the metallic base.

The solute in the adhesive is at least one selected from the group consisting of epoxy resin, polyurethane, polyolefin, polyester, styrene-butadiene rubber, gelatin, polyvinyl butyral, polyamide, rosin resin, polyvinyl alcohol, alkyd resin, polyvinyl acetate and etc. The polyolefin is at least one selected from the group consisting of polypropylene, polyvinyl chloride and polystyrene.

The solvent in the adhesive may be at least one selected from the group consisting of water, ethanol, ester of diacid, cyclohexane, heptane, tetrahydrofuran and common aromatic solvents. The aromatic solvent is at least one selected from the group consisting of benzyl alcohol, phenethyl alcohol, xylol, ethylbenzene and toluene.

The ink-repulsive layer is obtained by coating a mixed liquid of silicon rubber and curing agent or coating an organic solution of fluorine-containing resin and drying. The mixing ratio between the silicon rubber and the curing agent in the mixed liquid is determined by the type of the used silicon rubber. Generally, the mass ratio between the silicon rubber and the curing agent may be 5:1˜15:1, and the coating amount of the mixed liquid of the silicon rubber and the curing agent may be 0.001˜5 g/m². The content of fluorine-containing resin in the mixed liquid of fluorine-containing resin and organic solvent for coating may be 0.01˜20 wt % and the coating amount of the mixed liquid of fluorine-containing resin and organic solvent may be 0.001˜5 g/m². Preferably, the ink-repulsive layer is coated on the whole surface of the metallic base.

Preferably, the silicon rubber is polydimethylsiloxane, and/or product obtained by replacing one or two methyl in polydimethylsiloxane with vinyl, phenyl, C2˜C6 alkyl or halogeno phenyl (the halogen is Cl, Br or I). The curing agent preferably is a silane derivative or metal salt of organic carboxylic acid. The silane derivative is preferably silicone oil, methyl silicone oil, aminosilane, aminopropyl silane, methoxy silane, ethyoxyl silane and etc. The metal salt of organic carboxylic acid is preferably dibutyltin dilaurate and/or zinc chloroplatinate.

The fluorine-containing resin may be at least one selected from fluorine-containing acrylic resin, fluorine-containing isocyanate resin, fluorine-containing epoxy resin, fluorine-containing polyolefin resin and etc. The olefin in the fluorine-containing polyolefin resin is at least one selected from polypropylene, polyvinyl chloride, polystyrene and etc.

The organic solvent may be at least one selected from the group consisting of dimethyl sulfoxide, xylol, butyl acetate, ethylene glycol, propanediol, butanol, acetone, chloroform and etc.

The metallic base may be aluminum base used in ordinary printing production, or alloy base. The alloy base may be an alloy base of silica and aluminum. The content of silica in the alloy base is 30˜60 wt % (during smelting of aluminum, silica accounting for 30˜60 wt % of the total amount of silica and aluminum is added). An alloy base of aluminum and zinc, in which a content of the zinc is 1˜3 wt % or an alloy base of aluminum and iron, in which a content of the iron is 0.1˜1 wt % may also be used. Aluminum base or silica-containing aluminum alloy base is preferred. According to the plate provided by the present invention, the metallic base may skip the treatments of electrolytic graining and anodizing, and preferably does not undergo the treatments of electrolytic graining and anodizing to avoid the production of waste acid solution and waste base solution, which are harmful to the environment.

The method for preparing the plate for inkjet computer-to-plate of the present invention may comprise the following steps: adhesive sol consisting of solute and solvent is coated on the surface of the metallic base, and an adhesive layer is obtained after the solvent is removed by drying; an ink repulsive liquid, which is a mixed liquid of silicon rubber and curing agent or a mixed liquid of fluorine-containing resin and organic solvent, is coated on the adhesive layer; an ink repulsive layer, which is a mixture of silicon rubber and curing agent, is obtained after the silicon rubber is cured by drying, or an ink repulsive layer, which is fluorine-containing resin, is obtained after the solvent is removed by drying; as a result, the plate for inkjet computer-to-plate is obtained.

The plate for inkjet computer-to-plate may be further covered with a protective layer, which may be a polymer film having a thickness of 1˜20 μm, to obtain a plate for inkjet computer-to-plate with a protective layer.

The composition and coating amount of the adhesive sol have been described hereinbefore, so they are omitted herein for the purpose of brief.

The composition and coating amount of the mixed liquid of silicon rubber and curing agent as well as the organic solution of fluorine-containing resin have been described hereinbefore, so they are omitted herein for the purpose of brief.

The metallic base used in the present invention without undergoing the treatments of electrolytic graining and anodizing is coated with adhesive on the surface and then coated with an ink-repulsive liquid, to obtain a plate for inkjet computer-to-plate. The obtained plate for inkjet computer-to-plate may be further covered with a polymer film as a protective layer, to protect the plate from scratch during transport. The coating adhesive on the surface of the metallic plate has an effect of enhancing the binding power between the metallic base and the ink-repulsive liquid. Due to low surface tension, the obtained ink-repulsive layer is not sticky to the printing ink during printing.

According to another object of the present invention, an inkjet printing method is provided, comprising the following steps: imparting image-text information on the plate of the present invention by using plate-making ink, and printing the plate having the image-text information, so as to obtain a presswork. The printing area with plate-making ink is an image-text zone, which shows affinity to ink during printing, while the area without plate-making ink is a non-image-text zone, which is not sticky to ink during printing, thereby realizing the contrast between the text-image zone and the non-text-image zone. By using the plate of the present invention, excellent printing durability and resolution can be obtained.

The method for printing image-text information on a plate with plate-making ink and the method for using the plate with image-text information to print may be conventional methods in the art.

If the plate has a protective layer, the film as the protective layer is removed before printing.

The plate-making ink may be various kinds of environment friendly water-based ink or solvent-based ink suitable for plate making.

Preferably, the plate-making ink is solvent-based ink, which comprises:

| | |
|---|---|
| film forming resin | 1~35 wt % |
| curing agent | 0.01~5 wt % |
| nano-scale or micron-scale dyestuff | 0.01~10 wt % |
| solvent | balance amount. |

According to the preferred embodiment, the printing durability and resolution may be further improved.

The method for preparing the solvent-based plate-making ink may comprise the following steps: mixing 1˜35 wt % film forming resin, 0.01˜5 wt % curing agent, 0.01˜10 wt % nano-scale or micron-scale dyestuff and balance amount of solvent, stirring the mixed solution at room temperature till the solid solute is thoroughly dissolved, and filtering the obtained solution to remove the undissolved particles and impurities, and the obtained filtrate is solvent-based plate-making ink of the present invention.

The film forming resin in the plate-making ink is at least one selected from the group consisting of polyacrylic acid resin, polymethacrylic acid resin, ester of polyacrylic acid resin, ester of polymethacrylic acid resin, polyimide resin, methyl silicone resin, polyester resin, epoxy resin, phenolic resin, polyurethane resin, benzoxazine resin, alkyd resin, rubber, polyamide, polyvinyl chloride, polystyrene, polycarbonate, polyphenyl ether, polysulfone and etc.

The ester of polyacrylic acid resin comprises a product of esterification reaction between the polyacrylic acid resin and C1˜C5 monobasic alcohols. When the reactants are added, the molar ratio between polyacrylic acid resin and monobasic alcohols may be 1:10˜10:1. The ester of the polymethacrylic acid resin comprises a product of esterification reaction between the polymethacrylic acid resin and C1˜C5 monobasic alcohols. When the reactants are added, the molar ratio between polymethacrylic acid resin and monobasic alcohols may be 1:10˜10:1.

The curing agent in the plate-making ink may be at least one selected from the group consisting of silicone oil, epoxy resin with a low molecular weight, dicyandiamide, melamine, ethanolamine, triethylamine, polyisocyanate, benzoyl peroxide, acetic anhydride, 2-ethylimidazole, 2,4-dimethyl imidazole, mellophanic dianhydride and N,N-dimethylaniline.

The epoxy equivalent value of the epoxy resin with a low molecular weight may be 100˜2000 g/equivalent.

The particle size of the nano-scale or micron-scale dyestuff in the plate-making ink may be 10˜3000 nm.

The dyestuff in the plate-making ink may be one of acidic dyestuff, active dyestuff or alkaline dyestuff.

The acidic dyestuff may be one of dye acid blue 9, dye acid blue 9 SF and dye acid yellow 23 SF. The active dyestuff may be one of black dyestuff SP series or reactive black. The alkaline dyestuff may be one of basic brilliant blue and N,N-dimethylaniline in blue dyestuff.

The solvent in the plate-making ink may be one selected from ethylene glycol monomethyl ether, ethylene glycol monoethyl ether, ethylene glycol mono-n-butyl ether, ethylene glycol dimethyl ether, propylene glycol monomethyl ether, propylene glycol monoethyl ether, propylene glycol monomethyl ether acetate, propylene glycol monoethyl ether acetate, propylene glycol monobutyl ether acetate, ethylene glycol monobutyl ether acetate, N,N-dimethylformamide, dioxane, sec-butyl acetate, A grade mineral essential oil and B grade mineral essential oil.

The plate for inkjet computer-to-plate of the present invention can achieve excellent printing durability and resolution without making the metallic base undergo the treatments of electrolytic graining and anodizing, thereby avoiding the serious environmental hazard of waste acid solution and waste base solution produced in the process of electrolytic graining and anodizing.

### DETAILED DESCRIPTION OF THE EMBODIMENTS

### Example 1

After an industrial aluminum base without undergoing the treatments of electrolytic graining and anodizing is degreased with a dilute aqueous solution of sodium hydroxide at a concentration of 5 wt % and washed with water, adhesive sol is coated on the surface of the aluminum base by method of spin coating. The coated adhesive sol is a benzyl alcohol solution of epoxy resin at a concentration of 0.05 wt %. The coating amount of the adhesive sol is 0.001 g/m². Benzyl alcohol is removed by drying, to obtain an epoxy resin adhesive. An ink repulsive liquid consisting of polydimethylsiloxane and silicone oil is coated on the adhesive layer of epoxy resin. The mass ratio between polydimethylsiloxane and silicone oil is 5:1. The coating amount of the ink repulsive liquid is 5 g/m². Polydimethylsiloxane is cured by drying to obtain an ink repulsive layer, which is formed from a mixture of polydimethylsiloxane and silicone oil. Thereby, an aluminum plate for inkjet computer-to-plate is obtained. A polyethylene film with a thickness of 1 μm is covered on the obtained aluminum plate as the protective film.

1 wt % polyacrylic acid resin, 5 wt % triethanolamine, 0.01 wt % basic brilliant blue (with a particle size of 10 nm) and the balance amount of ethylene glycol dimethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 2

After an industrial aluminum alloy base (containing SiO₂ at a content of 60 wt %) without electrolytic graining and anodizing is degreased with a dilute aqueous solution of sodium hydroxide at a concentration of 5 wt % and washed with water, adhesive sol is coated on the surface of the aluminum base by method of spin coating. The coated adhesive sol is a benzyl alcohol solution of epoxy resin at a concentration of 15 wt %. The coating amount of the adhesive sol is 10 g/m². Benzyl alcohol is removed by drying, to obtain an adhesive layer of epoxy resin. An ink repulsive liquid consisting of polymethylvinylsiloxane and methyl silicone oil is coated on the adhesive layer of epoxy resin. The mass ratio between polymethylvinylsiloxane and methyl silicone oil is 15:1. The coating amount of the ink repulsive liquid is 0.001 g/m². Polymethylvinylsiloxane is cured by drying to obtain an ink repulsive layer, which is formed from a mixture of polymethylvinylsiloxane and methyl silicone oil. Thereby, an aluminum plate for inkjet computer-to-plate is obtained. A polypropene film with a thickness of 20 μm is covered on the obtained aluminum plate as the protective film.

35 wt % phenolic resin, 0.01 wt % epoxy resin with an epoxy equivalent value of 100 g/equivalent, 0.01 wt % black dyestuff SP (with a particle size of 3000 nm) and the balance amount of ethylene glycol mono-methyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 3

After an industrial aluminum base without electrolytic graining and anodizing is degreased with a dilute aqueous solution of sodium hydroxide at a concentration of 5 wt % and washed with water, adhesive sol is coated on the surface of the aluminum base by method of spin coating. The coated adhesive sol is a xylene solution of polyurethane at a concentration of 0.05 wt %. The coating amount of the adhesive sol is 1 g/m². The xylene is removed by drying, to obtain an adhesive layer of polyurethane. An ink repulsive liquid consisting of dimethylsulfoxide solution of fluorine-containing isocyanate resin at a concentration of 20 wt % is coated on the adhesive layer of polyurethane resin. The coating amount of the ink repulsive liquid is 5 g/m². Dimethylsulfoxide is removed by drying to obtain an ink repulsive layer, which is formed from fluorine-containing isocyanate resin. Thereby, an aluminum plate for inkjet computer-to-plate is obtained. A polypentene film with a thickness of 10 μm is covered on the obtained aluminum plate as the protective film.

20 wt % epoxy resin, 2 wt % polyisocyanate, 10 wt % dye acid blue 9 (with a particle size of 2000 nm) and the balance amount of ethylene glycol mono-n-butyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 4

After an industrial aluminum alloy base (containing SiO₂ at a content of 40 wt %) without undergoing the treatments of electrolytic graining and anodizing is degreased with a 5 wt % dilute aqueous solution of sodium hydroxide at a concentration of 5 wt % and washed with water, adhesive sol is coated on the surface of the aluminum alloy base by method of spin coating. The coated adhesive sol is xylol solution of polyurethane at a concentration of 15 wt %. The coating amount of the adhesive sol is 2 g/m². Xylol is removed by drying to obtain a polyurethane adhesive layer. An ink repulsive liquid consisting of xylol solution of fluorine-containing acrylic resin at a concentration of 0.01 wt % is coated on the polyurethane adhesive layer. The coating amount of the ink repulsive liquid is 0.001 g/m². Xylol is removed by drying to obtain an ink repulsive layer, which is formed from fluorine-containing acrylic resin. Thereby, aluminum plate for inkjet computer-to-plate is obtained. A polyvinylidene film with a thickness of 10 μm is covered on the obtained aluminum plate as the protective layer.

15 wt % polyimide resin, 0.03 wt % triethylamine, 5 wt % reactive black (with a particle size of 30 nm) and the balance amount of propylene glycol mono-methyl ether acetate, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 5

After an industrial aluminum alloy base (containing SiO₂ at a content of 30 wt %) without undergoing the treatments of electrolytic graining and anodizing is degreased with a dilute aqueous solution of sodium hydroxide at a concentration of 5 wt % and washed with water, adhesive sol is coated on the surface of the aluminum base by method of spin coating. The coated adhesive sol is tetrahydrofuran solution of polystyrene at a concentration of 0.05 wt %. The coating amount of the adhesive sol is 1.5 g/m². Tetrahydrofuran is removed by drying to obtain a polystyrene adhesive layer. An ink repulsive liquid consisting of polyphenylmethylsiloxane and dibutyltin dilaurate is coated on the polystyrene adhesive layer. The mass ratio between polyphenylmethylsiloxane and dibutyltin dilaurate is 6:1. The coating amount of the ink repulsive liquid is 2 g/m². Polyphenylmethylsiloxane is cured by drying to obtain an ink repulsive layer, which is formed from a mixture of polyphenylmethylsiloxane and dibutyltin dilaurate. Thereby, an aluminum plate for inkjet computer-to-plate is obtained. A polyallene with a thickness of 5 μm is covered on the obtained aluminum plate as the protective layer.

35 wt % polymethacrylic acid resin, 4 wt % melamine, 1 wt % N,N-dimethylaniline (with a particle size of 100 nm) and the balance amount of ethylene glycol monoethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 6

After an industrial aluminum alloy base (containing SiO₂ at a content of 60 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy base. The coated adhesive sol is a benzyl alcohol solution of polystyrene at a concentration of 15 wt %. The coating amount of the adhesive sol is 2.5 g/m². Benzyl alcohol is removed by drying to obtain a polystyrene adhesive layer. An ink repulsive liquid consisting of polymethylethylsiloxane and aminosilane is coated on the polystyrene adhesive layer. The mass ratio between polymethylethylsiloxane and aminosilane is 8:1. The coating amount of the ink repulsive liquid is 1 g/m². Polymethylethylsiloxane is cured by drying to obtain an ink repulsive layer, which is formed from a mixture of polymethylethylsiloxane and aminosilane. Thereby, an aluminum plate for inkjet computer-to-plate is obtained. A polyvinyl alcohol film with a thickness of 12 μm is covered on the obtained aluminum plate as a protective layer.

5 wt % methyl silicone resin, 0.03 wt % dicyandiamide, 0.01 wt % silicone oil, 1 wt % dye acid yellow 23 SF (with a particle size of 1000 nm) and the balance amount of propylene glycol monomethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 7

After an industrial aluminum alloy base (containing SiO₂ at a content of 40 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy base. The coated adhesive sol is an aqueous solution of gelatin at a concentration of 0.05 wt %. The coating amount of the adhesive sol is 4 g/m². Water is removed by drying to obtain a gelatin adhesive layer. An ink repulsive liquid consisting of a butyl acetate solution of fluorine-containing epoxy resin at a concentration of 0.01 wt % is coated on the gelatin adhesive layer. The coating amount of the ink repulsive liquid is 0.005 g/m². Butyl acetate is removed by drying to obtain an ink repulsive layer, which is formed from fluorine-containing epoxy resin. Thereby, an aluminum plate for inkjet computer-to-plate is obtained. A polyvinyl butyral film with a thickness of 6 μm is covered on the obtained aluminum plate as a protective layer.

5 wt % product of the reaction between polyacrylic acid resin and methanol (during addition of reactants, the molar ratio between polyacrylic acid and methanol is 1:2), 0.03 wt % epoxy resin with an epoxy equivalent value of 2000 g/equivalent, 1 wt % basic brilliant blue (with a particle size of 2000 nm) and the balance amount of propylene glycol monoethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 8

After an industrial aluminum alloy base (containing SiO₂ at a content of 50 wt %) without undergoing the treatments of electrolytic graining and anodizing is degreased with a dilute aqueous water solution of sodium hydroxide at a concentration of 5 wt % and washed with water, the aluminum alloy base is subject to coat by method of spin coating. Adhesive sol is coated on the surface of the aluminum base. The coated adhesive sol is an aqueous solution of gelatin at a content of 15 wt %. The coating amount of the adhesive sol is 1.5 g/m². Water is removed by drying to obtain a gelatin adhesive layer. An ink repulsive liquid consisting of ethylene glycol (40 wt %) and propanediol (40 wt %) solution of fluorine-containing polyethylene resin at a concentration of 20 wt % is coated on the gelatin adhesive layer. The coating amount of the ink repulsive liquid is 3 g/m². Ethylene glycol and propanediol are removed by drying to obtain an ink repulsive layer, which is formed from fluorine-containing polyethylene resin. Thereby, an aluminum plate for inkjet computer-to-plate is obtained. A polystyrene film with a thickness of 3 μm is covered on the obtained aluminum plate as a protective layer.

5 wt % product of the reaction between polymethacrylic acid resin and methanol (during addition of reactants, the molar ratio between polymethacrylic acid and methanol is 1:2), 0.03 wt % epoxy resin with an epoxy equivalent value of 100 g/equivalent, 1 wt % basic brilliant blue (with a particle size of 2000 nm) and the balance amount of propylene glycol monoethyl ether acetate, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 9

After an industrial aluminum alloy base (containing SiO₂ at a content of 30 wt %) without undergoing treatments of electrolytic graining and anodizing is degreased with a dilute aqueous solution of sodium hydroxide at a content of 5 wt % and washed with water, the aluminum alloy base is subject to coat by method of spin coating. Adhesive sol is coated on the surface of the aluminum alloy plate. The coated adhesive sol is an ethanol solution of alkyd resin at a concentration of 0.05 wt %. The coating amount of the adhesive sol is 0.5 g/m². Ethanol is removed by drying to obtain an alkyd resin adhesive layer. An ink repulsive liquid consisting of polymethylpropylsiloxane and aminopropyl silane is coated on the alkyd resin adhesive layer. The mass ratio between polymethylpropylsiloxane and aminopropyl silane is 10:1. The coating amount of the ink repulsive liquid is 0.01 g/m². Polymethylpropylsiloxane is cured by drying to obtain an ink repulsive layer, which is formed from a mixture of polymethylpropylsiloxane and aminopropyl silane. Thereby, an aluminum plate for inkjet computer-to-plate is obtained. A polyethylene terephthalate film with a thickness of 16 μm is covered on the obtained aluminum plate as the protective layer.

20 wt % polyester resin, 0.02 wt % benzoyl peroxide, 0.02 wt % black dyestuff SP (with a particle size of 3000 nm) and the balance amount of propylene glycol monobutyl ether acetate, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 10

After an industrial aluminum alloy base (containing SiO₂ at a content of 30 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy base. The coated adhesive sol is an ethanol solution alkyd resin at a concentration of 15 wt %. The coating amount of the adhesive sol is 0.02 g/m². Ethanol is removed by drying to obtain an alkyd resin adhesive layer. An ink repulsive liquid consisting of polymethylcyclohexylsiloxane and dibutyltin dilaurate is coated on the alkyd resin adhesive layer. The mass ratio between polymethylcyclohexylsiloxane and dibutyltin dilaurate is 12:1. The coating amount of the ink repulsive liquid is 0.005 g/m². Polymethylcyclohexylsiloxane is cured by drying to obtain an ink repulsive layer, which is formed from a mixture of polymethylcyclohexylsiloxane and dibutyltin dilaurate. Thereby, an aluminum plate for inkjet computer-to-plate is obtained. A polyvinyl chloride film with a thickness of 9 μm is covered on the obtained aluminum plate as the protective layer.

20 wt % rubber, 0.02 wt % benzoyl peroxide, 0.02 wt % black dyestuff SP (with a particle size of 3000 nm) and the balance amount of ethyl glycol monobutyl ether acetate, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 11

After an industrial aluminum base without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum base. The coated adhesive sol is ester of diacid solution of polyester at a concentration of 0.05 wt %. The coating amount of the adhesive sol is 0.005 g/m². Ester of diacid is removed by drying to obtain a polyester adhesive layer. An ink repulsive liquid consisting of a butanol solution of fluorine-containing acrylic resin at a content of 0.01 wt % is coated on the polyester adhesive layer. The coating amount of the ink repulsive liquid is 4 g/m². Butanol is removed by drying to obtain an ink repulsive layer, which is formed from fluorine-containing acrylic resin. Thereby, an aluminum plate for inkjet computer-to-plate is obtained. A poly(vinylidene dichloride) film with a thickness of 8 μm is covered on the obtained aluminum plate as the protective layer.

1 wt % polystyrene, 4 wt % N,N-dimethylaniline, 10 wt % acid blue 9 (with a particle size of 800 nm) and the balance amount of N,N-dimethylformamide, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 12

After an industrial aluminum alloy base (containing SiO₂ at a content of 40 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy base. The coated adhesive sol is an ester of diacid solution of polyester at a concentration of 15 wt %. The coating amount of the adhesive sol is 0.01 g/m². Ester of diacid is removed by drying to obtain a polyester adhesive layer. An ink repulsive liquid consisting of an acetone solution of fluorine-containing epoxy resin at a concentration of 20 wt % is coated on the polyester adhesive layer. The coating amount of the ink repulsive liquid is 0.2 g/m². Acetone is removed by drying to obtain an ink repulsive layer, which is formed from fluorine-containing epoxy resin. Thereby, an aluminum plate for inkjet computer-to-plate is obtained. A polyethylene terephthalate film with a thickness of 2 μm is covered on the obtained aluminum plate as the protective layer.

1 wt % polyamide, 4 wt % N,N-dimethylaniline, 10 wt % acid blue 9 (with a particle size of 800 nm) and the balance amount of dioxane, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 13

After an industrial aluminum alloy base (containing SiO₂ at a content of 45 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum base. The coated adhesive sol is an aqueous solution of polyvinyl alcohol at a concentration of 0.05 wt %. The coating amount of the adhesive sol is 0.06 g/m². Water is removed by drying to obtain a polyvinyl alcohol adhesive layer. An ink repulsive liquid consisting of polymethylisobutylsiloxane and methoxy silane is coated on the polyvinyl alcohol adhesive layer. The mass ratio between polymethylisobutylsiloxane and methoxy silane is 9:1. The coating amount of the ink repulsive liquid is 2.5 g/m². Polymethylisobutylsiloxane is cured by drying to obtain an ink repulsive layer, which is formed from a mixture of polymethylisobutylsiloxane and methoxy silane. Thereby, an aluminum plate for inkjet computer-to-plate is obtained. A polypentylene film with a thickness of 13 μm is covered on the obtained aluminum plate as the protective layer.

35 wt % product of the reaction between polyacrylic acid resin and pentanol (during addition of reactants, the molar ratio between polyacrylic acid resin and pentanol is 1:2), 0.02 wt % diethanolamine, 1 wt % dye acid yellow 23 SF (with a particle size of 2000 nm) and the balance amount of sec-butyl acetate, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 14

After an industrial aluminum alloy base (containing SiO₂ at a content of 35 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy plate. The coated adhesive sol is an aqueous solution of polyvinyl alcohol at a concentration of 15 wt %. The coating amount of the adhesive sol is 0.45 g/m². Water is removed by drying to obtain a polyvinyl alcohol adhesive layer. An ink repulsive liquid consisting of polyethylvinylsiloxane and ethyoxyl silane is coated on the polyvinyl alcohol adhesive layer. The mass ratio between polyethylvinylsiloxane and ethyoxyl silane is 7:1. The coating amount of the ink repulsive liquid is 1.5 g/m². Polyethylvinylsiloxane is cured by drying to obtain an ink repulsive layer, which is formed from a mixture of polyethylvinylsiloxane and ethyoxyl silane. Thereby, an aluminum plate for inkjet computer-to-plate is obtained. A polyallene film with a thickness of 1 μm is covered on the obtained aluminum plate as the protective layer.

35 wt % polyvinyl chloride, 0.02 wt % diethanolamine, 1 wt % dye acid yellow 23 SF (with a particle size of 2000 nm) and the balance amount of A grade mineral essential oil, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 15

After an industrial aluminum alloy base (containing SiO₂ at a content of 60 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy plate. The coated adhesive sol is an ethylbenzene solution of polyvinyl acetate at a concentration of 0.05%. The coating amount of the adhesive sol is 0.004 g/m². Ethylbenzene is removed by drying to obtain a polyvinyl acetate adhesive layer. An ink repulsive liquid consisting of a chloroform solution of fluorine-containing isocyanate at a concentration of 20 wt % is coated on the polyvinyl acetate adhesive layer. The coating amount of the ink repulsive liquid is 0.5 g/m². Chloroform is removed by drying to obtain an ink repulsive layer, which is formed from fluorine-containing isocyanate. Thereby, an aluminum plate for inkjet computer-to-plate is obtained. A polystyrene film with a thickness of 10 μm is covered on the obtained aluminum plate as the protective layer.

20 wt % polycarbonate, 0.01 wt % N,N-dimethylaniline, 0.01 wt % black dyestuff SP (with a particle size of 3000 nm) and the balance amount of 13 grade mineral essential oil, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 16

After an industrial aluminum alloy base (containing SiO₂ at a content of 30 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum base. The coated adhesive sol is an ethylbenzene solution of polyvinyl acetate at a concentration of 15%. The coating amount of the adhesive sol is 9 g/m². Ethylbenzene is removed by drying to obtain a polyvinyl acetate adhesive layer. An ink repulsive liquid consisting of a dimethylsulfoxide solution of fluorine-containing polyethylene at a concentration of 0.01 wt % is coated on the polyvinyl acetate adhesive layer. The coating amount of the ink repulsive liquid is 3 g/m². Dimethylsulfoxide is removed by drying to obtain an ink repulsive layer, which is formed from fluorine-containing polyethylene. Thereby, an aluminum plate for inkjet computer-to-plate is obtained. A polyvinyl butyral film with a thickness of 5 μm is covered on the obtained aluminum plate as the protective layer.

1 wt % polyphenyl ether, 0.01 wt % N,N-dimethylaniline, 0.01 wt % black dyestuff SP (with a particle size of 3000 nm) and the balance amount of ethylene glycol monomethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 17

After an industrial aluminum alloy base (containing SiO₂ at a content of 32 wt %) without undergoing the treatments of electrolytic graining and anodizing is degreased with a dilute aqueous solution of sodium hydroxide at a concentration of 5 wt % and washed with water, adhesive sol is coated on the surface of the aluminum alloy plate by method of spin coating. The coated adhesive sol is a benzyl alcohol solution of polyvinyl butyral at a concentration of 0.9 wt %. The coating amount of the adhesive sol is 0.015 g/m². Benzyl alcohol is removed by drying to obtain a polyvinyl butyral adhesive layer. An ink repulsive liquid consisting of polydimethylsiloxane and silicone oil is coated on the polyvinyl butyral adhesive layer. The mass ratio between polydimethylsiloxane and silicone oil is 7:1. The coating amount of the ink repulsive liquid is 5 g/m². Polydimethylsiloxane is cured by drying to obtain an ink repulsive layer, which is formed from a mixture of polydimethylsiloxane and silicone oil. Thereby, an aluminum plate for inkjet computer-to-plate is obtained. A polyethylene film with a thickness of 1 μm is covered on the obtained aluminum plate as the protective layer.

5 wt % polyurethane resin, 5 wt % triethanolamine, 0.01 wt % basic brilliant blue (with a particle size of 10 nm) and the balance amount of ethylene glycol dimethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 18

After an industrial aluminum alloy base (containing SiO₂ at a content of 50 wt %) without undergoing the treatments of electrolytic graining and anodizing is degreased with a dilute aqueous solution of sodium hydroxide at a concentration of 5 wt % and washed with water, adhesive sol is coated on the surface of the aluminum alloy base by method of spin coating. The coated adhesive sol is a xylol solution of polyamide at a concentration of 10 wt %. The coating amount of the adhesive sol is 6 g/m². Xylol is removed by drying to obtain a polyamide adhesive layer. An ink repulsive liquid consisting of polymethylvinylsiloxane and methyl silicone oil is coated on the polyamide adhesive layer. The mass ratio between polymethylvinylsiloxane and methyl silicone oil is 8:1. The coating amount of the ink repulsive liquid is 0.001 g/m². Polymethylvinylsiloxane is cured by drying to obtain an ink repulsive layer, which is formed from a mixture of polymethylvinylsiloxane and silicone oil. Thereby, an aluminum plate for inkjet computer-to-plate is obtained. A polypropylene film with a thickness of 20 μm is covered on the obtained aluminum plate as the protective layer.

20 wt % alkyd resin, 0.01 wt % epoxy resin with an epoxy equivalent value of 100 g/equivalent, 0.01 wt % black dyestuff SP (with a particle size of 3000 nm) and the balance amount of ethylene glycol monomethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 19

After an industrial aluminum alloy base (containing SiO₂ at a content of 45 wt %) without undergoing the treatments of electrolytic graining and anodizing is degreased with a dilute aqueous solution of sodium hydroxide at a concentration of 5 wt % and washed with water, adhesive sol is coated on the surface of the aluminum alloy plate by method of spin coating. The coated adhesive sol is a cyclohexane solution of rosin resin at a concentration of 1.5 wt %. The coating amount of the adhesive sol is 1.2 g/m². Cyclohexane is removed by drying to obtain a rosin resin adhesive layer. An ink repulsive liquid consisting of a dimethylsulfoxide solution of fluorine-containing isocyanate resin at a concentration of 20 wt % is coated on the rosin resin adhesive layer. The coating amount of the ink repulsive liquid is 5 g/m². Dimethylsulfoxide is removed by drying to obtain an ink repulsive layer, which is formed from fluorine-containing isocyanate resin. Thereby, an aluminum plate for inkjet computer-to-plate is obtained. A polypentylene film with a thickness of 10 μm is covered on the obtained aluminum plate as the protective layer.

15 wt % benzoxazine resin, 2 wt % polyisocyanate, 10 wt % dye acid blue 9 (with a particle size of 2000 nm) and the balance amount of ethylene glycol mono-n-butyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

### Example 20

After an industrial aluminum alloy base (containing SiO₂ at a content of 40 wt %) without undergoing the treatments of electrolytic graining and anodizing is degreased with a dilute aqueous solution of sodium hydroxide at a concentration of 5 wt % and washed with water, the aluminum alloy base is subject to coat by method of spin coating. Adhesive sol is coated on the surface of the aluminum alloy base. The coated adhesive sol is a heptane solution of styrene-butadiene rubber at a concentration of 3 wt %. The coating amount of the adhesive sol is 0.04 g/m². Heptane is removed by drying to obtain a styrene-butadiene rubber adhesive layer. An ink repulsive liquid consisting of polymethylcyclohexylsiloxane and dibutyltin dilaurate is coated on the styrene-butadiene rubber adhesive layer. The mass ratio between polymethylcyclohexylsiloxane and dibutyltin dilaurate is 10:1. The coating amount of the ink repulsive liquid is 0.01 g/m². Polymethylcyclohexylsiloxane is cured by drying to obtain an ink repulsive layer, which is formed from a mixture of polymethylcyclohexylsiloxane and dibutyltin dilaurate. Thereby, an aluminum plate for inkjet computer-to-plate is obtained. A polyvinyl chloride with a thickness of 9 μm is covered on the obtained aluminum plate as the protective layer.

15 wt % polysulfone, 5 wt % epoxy resin with an epoxy equivalent value of 100 g/equivalent, 0.01 wt % black dyestuff SP (with a particle size of 3000 nm) and the balance amount of ethylene glycol monomethyl ether, which constitute solvent-based plate-making ink, are mixed and stirred at room temperature till all solid solutes are thoroughly dissolved. The undissolved particles and impurities are removed by filtration. The obtained filtrate is the solvent-based plate-making ink.

The solvent-based plate-making ink obtained in Examples 1˜20 is respectively sprayed by an inkjet printer onto the aluminum plates for the inkjet computer-to-plate obtained in the corresponding example (removing the protective layer) to form images. Then the aluminum plates sprayed with the plate-making ink are baked at 90˜300° C. so that the plate-making ink is crosslinked to cure under the action of the curing agent in the plate-making ink. After the foregoing treatment, the aluminum plates are used to print on a machine. According to the test result, the printing plates have good printing suitability and the printing durability may reach about 100000 pieces. The resolution of the line in the image-text of the plates may reach 10 μm. 5˜95% of the dots are complete and clear.

### Example 21

Blackjet ink (SPECTRA, UK) is respectively sprayed by an inkjet printer onto the aluminum plates for inkjet computer-to-plate obtained in Examples 1-20 (removing the protective layer) to form images. Then the aluminum plates sprayed with the plate-making ink are baked at 90˜300° C. so that the plate-making ink is crosslinked to cure under the action of the curing agent in the plate-making ink. After the foregoing treatment, the aluminum plates are used to print on a machine. According to the test result, the printing plates have good printing suitability and the printing durability may reach about 10000 pieces. The resolution of the line in the image-text of the plates may reach 20 μm. 10˜90% of the dots are complete and clear.

### Example 22

Seiko ink (SOLVENT INK, Japan) is respectively sprayed by an inkjet printer onto the aluminum plates for inkjet computer-to-plate obtained in Examples 1-20 (removing the protective layer) to form images. Then the aluminum plates sprayed with the plate-making ink are baked at 90˜300° C. so that the plate-making ink is crosslinked to cured under the action of the curing agent in the plate-making ink. After the foregoing treatment, the aluminum plates are used to print on a machine. According to the result of the test, the printing plates have good printing suitability and the printing durability may reach about 50000 pieces. The resolution of the line in the image-text of the plates may reach 15 μm. 5˜90% of the dots are complete and clear.

### Comparison Example 1

The industrial aluminum alloy base (containing SiO₂ at a content of 40 wt %) treated by electrolytic graining and anodizing (electrolyzed in a 1% HCl aqueous solution twice, 30s each time; anodized in a 15% H₂SO₄ aqueous solution) is degreased with a dilute aqueous solution of sodium hydroxide at a concentration of 5 wt % and washed with water, ink (SPT510, China) is sprayed on it by an inkjet printer to form an image. Then the aluminum plate sprayed with the plate-making ink is baked at 90˜300° C. so that the plate-making ink is crosslinked to cure under the action of the curing agent in the plate-making ink. After the foregoing treatment, the aluminum plate is used to print on a machine. According to the test result, the printing plate has good printing suitability and the printing durability may reach about 10000 pieces. The resolution of the lines in the image-text of the plate may reach 30 μm. 15˜85% of the dots are complete and clear.

### Comparison Example 2

After an industrial aluminum alloy base (containing SiO₂ at a content of 40 wt %) without undergoing the treatments of electrolytic graining and anodizing is degreased with a dilute aqueous solution of sodium hydroxide at a concentration of 5 wt % and washed with water, ink (P522-6, China) is sprayed on it by an inkjet printer to form an image. Then the aluminum plate sprayed with the plate-making ink is baked at 90˜300° C. so that the plate-making ink is crosslinked to cure under the action of the curing agent in the plate-making ink. After the foregoing treatment, the aluminum plate is used to print on a machine. According to the test result, the printing plate has good printing suitability and the printing durability may reach about 200 pieces. The resolution of the lines in the image-text of the plate only reaches 900 μm.

1. A plate for inkjet computer-to-plate, wherein the plate comprises a metallic base, an adhesive layer coated on the surface of the metallic base and an ink repulsive layer coated on the adhesive layer,
adhesive in the adhesive layer is at least one selected from the group consisting of epoxy resin, polyurethane, polyolefin, polyester, styrene-butadiene rubber, gelatin, polyvinyl butyral, polyamide, rosin resin, polyvinyl alcohol, alkyd resin and polyvinyl acetate,
the ink repulsive layer is a mixture of silicon rubber and curing agent or the ink repulsive layer is fluorine-containing resin.

2. The plate for inkjet computer-to-plate according to claim 1, wherein the ink repulsive layer is covered with a protective layer, which is a polymer film with a thickness of 1˜20 μm, polymer in the polymer film is at least one of polyethylene, polypropylene, polypentene, polyvinyl alcohol, polyvinyl butyral, polystyrene, polyethylene terephthalate, polyvinyl chloride and poly(vinylidene dichloride).

3. The plate for inkjet computer-to-plate according to claim 1, wherein the adhesive layer is obtained by coating and drying adhesive sol, wherein the adhesive sol for the coating consists of a solute and a solvent, concentration of the solute in the adhesive sol is 0.05˜15 wt %, coating amount of the adhesive sol is 0.001˜10 g/m², the solute is adhesive in the adhesive sol; and/or
the ink repulsive layer is obtained by coating a mixed liquid of silicon rubber and curing agent or by coating a mixed liquid of fluorine-containing resin and organic solution and drying, wherein mass ratio between the silicon rubber and the curing agent in the mixed liquid of silicon rubber and curing agent is 5:1˜15:1, coating amount of the mixed liquid of silicon rubber and curing agent is 0.001˜5 g/m², content of the fluorine-containing resin in the mixed liquid of fluorine-containing resin and organic solvent is 0.01˜20 wt %, coating amount of the mixed liquid of fluorine-containing resin and organic solvent is 0.001˜5 g/m².

4. The plate for inkjet computer-to-plate according to claim 1, wherein the polyolefin is at least one selected from the group consisting of polypropylene, polyvinyl chloride and polystyrene;
the fluorine-containing resin is at least one of fluorine-containing acrylic resin, fluorine-containing isocyanate resin, fluorine-containing epoxy resin and fluorine-containing polyolefin resin;
the silicon rubber is polydimethylsiloxane, and/or product obtained by replacing one or two methyl in polydimethylsiloxane with vinyl, phenyl, C2˜C6 alkyl or halogeno phenyl;
the curing agent is silane derivative and/or metal salt of organic carboxylic acid; the organic solvent is at least one selected from the group consisting of dimethyl sulfoxide, xylol, butyl acetate, ethylene glycol, propanediol, butanol, acetone and chloroform.

5. The plate for inkjet computer-to-plate according to claim 3, wherein the solvent is at least one selected from the group consisting of water, ethanol, ester of diacid, cyclohexane, heptane, tetrahydrofuran and aromatic solvent.

6. The plate for inkjet computer-to-plate according to claim 5, wherein the aromatic solvent is at least one selected from the group consisting of benzyl alcohol, phenethyl alcohol, xylol, ethylbenzene and toluene.

7. The plate for inkjet computer-to-plate according to claim 1, wherein the metal base is aluminum base or alloy base.

8. The plate for inkjet computer-to-plate according to claim 7, wherein the alloy base is an alloy base of silica and aluminum, in which a content of silica is 30˜60 wt %, or
an alloy base of aluminum and zinc, in which a content of the zinc is 1˜3 wt %, or
an alloy base of aluminum and iron, in which a content of the iron is 0.1˜1 wt %.

9. An inkjet printing method, comprising the following steps: imparting image-text information on the plate by using plate-making ink, and printing the plate having the image-text information, so as to obtain a presswork,
the plate comprises a metallic base, an adhesive layer coated on the surface of the metallic base and an ink repulsive layer coated on the adhesive layer,
adhesive in the adhesive layer is at least one selected from the group consisting of epoxy resin, polyurethane, polyolefin, polyester, styrene-butadiene rubber, gelatin, polyvinyl butyral, polyamide, rosin resin, polyvinyl alcohol, alkyd resin and polyvinyl acetate,
the ink repulsive layer is a mixture of silicon rubber and curing agent or the ink repulsive layer is fluorine-containing resin.

10. The inkjet printing method according to claim 9, wherein the plate-making ink is a solvent-based plate-making ink, which comprises:

| | |
|---|---|
| film forming resin | 1~35 wt % |
| curing agent | 0.01~5 wt % |
| nano-scale or micron-scale dyestuff | 0.01~10 wt % |
| solvent | balance amount |

the film forming resin is at least one selected from the group consisting of polyacrylic acid resin, polymethacrylic acid resin, ester of polyacrylic acid resin, ester of polymethacylic acid resin, polyimide resin, methyl silicone resin, polyester resin, epoxy resin, phenolic resin, polyurethane resin, benzoxazine resin, alkyd resin, rubber, polyamide, polyvinyl chloride, polystyrene, polycarbonate, polyphenyl ether and polysulfone;
the curing agent is at least one selected from the group consisting of silicone oil, epoxy resin with a low molecular weight, dicyandiamide, melamine, ethanolamine, triethylamine, polyisocyanate, benzoyl peroxide, acetic anhydride, 2-ethylimidazole, 2,4-dimethyl imidazole, mellophanic dianhydride and N,N-dimethylaniline;
the nano-scale or micron-scale dyestuff has a particle size of 10˜3000 nm.

11. The inkjet printing method according to claim 10, wherein the ester of polyacrylic acid resin comprises a product of esterification reaction between the polyacrylic acid resin and C1˜C5 monobasic alcohols; the ester of the polymethacylic acid resin comprises a product of esterification reaction between the polymethacrylic acid resin and C1˜C5 monobasic alcohols;
the epoxy resin with a low molecular weight has an epoxy equivalent value of 100˜2000 g/equivalent.

12. The inkjet printing method according to claim 10, wherein the dyestuff in the plate-making ink is one selected from acidic dyestuff, active dyestuff or alkaline dyestuff.

13. The inkjet printing method according to claim 12, wherein the acidic dyestuff is one of dye acid blue 9, dye acid blue 9 SF and dye acid yellow 23 SF;
the active dyestuff is one of black dyestuff SP series or reactive black;
the alkaline dyestuff is one of basic brilliant blue and N,N-dimethylaniline in blue dyestuffs.

14. The inkjet printing method according to claim 10, wherein the solvent in the plate-making ink is one selected from ethylene glycol monomethyl ether, ethylene glycol monoethyl ether, ethylene glycol mono-n-butyl ether, ethylene glycol dimethyl ether, propylene glycol monomethyl ether, propylene glycol monoethyl ether, propylene glycol monomethyl ether acetate, propylene glycol monoethyl ether acetate, propylene glycol monobutyl ether acetate, ethylene glycol monobutyl ether acetate, N,N-dimethylformamide, dioxane, sec-butyl acetate, A grade mineral essential oil and B grade mineral essential oil.

15. The plate for inkjet computer-to-plate according to claim 3, wherein the polyolefin is at least one selected from the group consisting of polypropylene, polyvinyl chloride and polystyrene;
the fluorine-containing resin is at least one of fluorine-containing acrylic resin, fluorine-containing isocyanate resin, fluorine-containing epoxy resin and fluorine-containing polyolefin resin;
the silicon rubber is polydimethylsiloxane, and/or product obtained by replacing one or two methyl in polydimethylsiloxane with vinyl, phenyl, C2˜C6 alkyl or halogeno phenyl;
the curing agent is silane derivative and/or metal salt of organic carboxylic acid;
the organic solvent is at least one selected from the group consisting of dimethyl sulfoxide, xylol, butyl acetate, ethylene glycol, propanediol, butanol, acetone and chloroform.

16. The inkjet printing method according to claim 9, wherein the adhesive layer is obtained by coating and drying adhesive sol, wherein the adhesive sol for the coating consists of a solute and a solvent, concentration of the solute in the adhesive sol is 0.05˜15 wt %, coating amount of the adhesive sol is 0.001˜10 g/m2, the solute is adhesive in the adhesive sol; and/or
the ink repulsive layer is obtained by coating a mixed liquid of silicon rubber and curing agent or by coating a mixed liquid of fluorine-containing resin and organic solution and drying, wherein mass ratio between the silicon rubber and the curing agent in the mixed liquid of silicon rubber and curing agent is 5:1˜15:1, coating amount of the mixed liquid of silicon rubber and curing agent is 0.001˜5 g/m2, content of the fluorine-containing resin in the mixed liquid of fluorine-containing resin and organic solvent is 0.01˜20 wt %, coating amount of the mixed liquid of fluorine-containing resin and organic solvent is 0.001˜5 g/m2.

17. The inkjet printing method according to claim 16, wherein the solvent is at least one selected from the group consisting of water, ethanol, ester of diacid, cyclohexane, heptane, tetrahydrofuran and aromatic solvent;
the aromatic solvent is at least one selected from the group consisting of benzyl alcohol, phenethyl alcohol, xylol, ethylbenzene and toluene.

18. The inkjet printing method according to claim 9, wherein the polyolefin is at least one selected from the group consisting of polypropylene, polyvinyl chloride and polystyrene;
the fluorine-containing resin is at least one of fluorine-containing acrylic resin, fluorine-containing isocyanate resin, fluorine-containing epoxy resin and fluorine-containing polyolefin resin;
the silicon rubber is polydimethylsiloxane, and/or product obtained by replacing one or two methyl in polydimethylsiloxane with vinyl, phenyl, C2˜C6 alkyl or halogeno phenyl;
the curing agent is silane derivative and/or metal salt of organic carboxylic acid;
the organic solvent is at least one selected from the group consisting of dimethyl sulfoxide, xylol, butyl acetate, ethylene glycol, propanediol, butanol, acetone and chloroform.

19. The inkjet printing method according to claim 9, wherein the metal base is aluminum base or alloy base.

20. The inkjet printing method according to claim 19, wherein the alloy base is an alloy base of silica and aluminum, in which a content of silica is 30˜60 wt %, or an alloy base of aluminum and zinc, in which a content of the zinc is 1˜3 wt %, or an alloy base of aluminum and iron, in which a content of the iron is 0.1˜1 wt %.
